(19) United States
(12) Patent Application Publication
(10) Pub. No.: US 2009/0204550 A1
(43) Pub. Date: Aug. 13, 2009

(54) Marketing plan for social change and resource reallocation through the sale and/or exchange of goods and services

(76) Inventor: Thomas Richmond Halkett, Machias, ME (US)

Correspondence Address: THOMAS R. HALKETT, PO BOX 564, MACHIAS, ME, 04654, US

(21) Appl. No.: 12/322,538

(22) Filed: Feb. 2, 2009

Related U.S. Application Data
(60) Provisional application No. 61/063,958, filed on Feb. 7, 2008.

(51) Int. Cl. G06Q 20/00; G06Q 90/00

(52) U.S. Cl. 705/400

(57) ABSTRACT

A method and system for marketing goods/services based on the incomes of the suppliers of the goods/services and the purchasers of those goods/services. Those suppliers of the goods/services who have the least income will receive the most remuneration. Those suppliers of the goods/services who have the greater income will receive the least remuneration. Purchasers use the same method. This marketing plan generates significant income for those two billion people in the world who live on less than US$2.00/day. An exponential methodology creates the rate structure for all participants.

### CROSS-REFERENCE TO RELATED APPLICATIONS

This application claims the benefit of provisional patent application Ser. No. 61/063,958, filed Feb. 7, 2008 by the present inventor.

### FEDERALLY SPONSORED RESEARCH:

Not applicable

### SEQUENCE LISTING OR PROGRAM:

Not applicable

### BACKGROUND

1. Field of the Invention

This business model relates generally to a marketing system and method, and in particular to a method and system for creating social change through resource reallocation through the exchange and/or sale of goods and services.

2. Prior Art

Marketing plans commonly seek to enhance gross profit. Generally, in a global economy, every corporate entity advances methods for generating optimal growth and stability for that corporate entity or nation state.

Several patented models assist in promoting global marketing strategies in order for first, the business entity to realize maximum profits, and second, when it benefits them, to help meet some of the social needs of the poorest people in our world. (U.S. Pat. No. 7,013,289, 2006, Horn et al., U.S. Pat. No. 6,662,355, 2003, Caswell, et al., U.S. Pat. No. 6,993,535, 2006, Bolle et al., U.S. Pat. No. 7,246,083, 2007, Bibelnieks, et al., and U.S. Pat. No. 7,165,052, Diveley et al.

Similarly, the authors of the books listed below, also offer apologetics for corporate and nation states to offer goods and services to the poor where first, they will generate additional profit because of taking greater risks within poor communities and second, it will give corporations and nation states the ability to create markets using products that are no longer needed in economically developed areas because of increasing technological advances. For further reference see: C. K. Prahad, 2006, chapter on a film/camera company developing a market in Brazil for photographic film sales after most of its traditional market was moving away from film to digital photography.

The secondary gain of a corporation such as the one noted above is when it manifests itself as the primary locus of this embodiment of social change and resource reallocation. That is, by selling or leasing film, cameras, and processing equipment to poor people, this corporation also opened up ways in which poor people could participate in creating wealth for themselves. This type of marketing plan for social change and resource reallocation focuses first on the needs of the poor, and second on the needs of a corporation or nation state. In this way, it differs substantially from any prior art whose marketing ideologies and methodologies promote systemic gain rather than opening up, in an intentional way, a marketing plan that promotes resource reallocation by shifting its focus to the poor and their needs.

| | | |
|---|---|---|
| 5,930,764 | July 1999 | Melchione, et al. |
| 6,026,376 | February 2000 | Kenney |
| 6,112,188 | August 2000 | Hartnett |
| 6,460,020 | October 2002 | Pool, et al. |
| 6,578,008 | June 2003 | Chacker |
| 6,662,355 | December 2003 | Caswell, et al. |
| 6,836,764 | December 2004 | Hucal |
| 6,859,795 | February 2005 | Zolotorev, et al. |
| 6,901,380 | May 2005 | Bremers |
| 6,922,675 | July 2005 | Chatterjee, et al. |
| 6,993,496 | January 2006 | Pittelli |
| 6,993,535 | January 2006 | Bolle, et al |
| 7,013,289 | March 2006 | Horn, et al. |
| 7,080,030 | July 2006 | Egden, et al. |
| 7,165,041 | January 2007 | Guheen, et al. |
| 7,165,052 | January 2007 | Diveley, et al. |
| 7,181,431 | February 2007 | Wasilewski |
| 7,246,083 | July 2007 | Bibelnieks, et al. |
| 7,257,561 | August 2007 | Abe |
| 7,389,259 | June 2008 | Duncan |

### OTHER REFERENCES

The Fortune At The Bottom of The Pyramid, eradicating poverty through profits, C. K. Prahalad, Pearson, 2006; ISBN 0-13-187729-1
Business Solutions For The Global Poor, creating social and economic value, V. Kasturi Rangan, John A. Quelch, Gustavo Herrero, and Brooke Barton, editors, Jossey-Bass 2007; ISBN 13: 978-0-7879-8216-4 (alk.) Paper) The End of Poverty economic possibilities for our time, Jeffrey D. Sachs, Penguin 2006; ISBN 0 14 30.3658

### SUMMARY

This method and system demonstrates that optimal economic growth for those who are very poor can occur in a market when that market contains cooperation among suppliers, purchasers, and businesses that organize around the above principles.

### DETAILED DESCRIPTION

The following merchandising plan will help create social change through resource reallocation in the sale/exchange of goods and services. Any product or service could be marketed in this manner. The manner in which that is done could be retail, wholesale, or any type of cooperative sale or exchange.

This structure requires the basic honesty of participants in reporting their incomes. An entity or person whose income is the highest will pay the most and receive the least for any goods or services that are purchased or created. Obversely, the person or entity whose income is the lowest will receive the most and pay the least for any goods or services that are created or purchased. The following chart outlines this system in an exponential way. Any numbers could be substituted in the following formula to create a method and system to market goods and or services based on the incomes of the suppliers and purchasers.

For the purpose of this example, the constants were selected to provide a range of income levels that reflect the incomes of most of the people in the world. A similar process could be constructed for businesses, corporations, and non-profit organizations.

The equation is f=ab where a=constant=(US$484.84), b=constant (1.65), and b=1. So, when t=0=f(0)=a(b)=a=$484.84. Likewise, when t=1−f(1)=ab=(484.84)(1.65)=800. This formula is used to arrive at a scale, in which incomes are denoted from US$484.84 to US$72,517.

The income guidelines are as follows: (in US dollars)
I. 484.84
II. 800.00
III. 1320.00
IV. 2178.00
V. 3595.00
VI. 5929.00
VII. 9784.00
VIII. 16143.00
IX. 26636.00
X. 43950.00
XI. 72517.00

Percentage of Good or Service Paid When it is Sold or Exchanged
I. 0+
II. 10
III. 20
IV. 30
V. 40
VI. 50
VII. 60
VIII. 70
IX. 80
X. 90
XI. 100

Percentage of Good or Service Received When it is Sold or Exchanged
I. 100
II. 90
III. 80
IV. 70
V. 60
VI. 50
VII. 40
VIII. 30
IX. 20
X. 10
XI. 0+

Each person whose income is in the upper portion of his or her income bracket would be in the next higher designation. Each person who was in the lower portion of their income bracket would be in the lower designation. For example: someone who earns US$6200.00 would be in category VI, and someone whose income is US$15,000.00 would be in category VIII.

In this model, if a good or service is valued at US$25.00, the person who produces that good or offers that service in exchange for goods or services valued at US$25.00 or desires to be compensated in currency of some kind, would receive full value should his or her income be US$484.00 or less. In a similar way, should this person desire to purchase or exchange goods or services, their cost would be minimal, either in goods, services, or currency.

If a person wanted to purchase a similar good or service, valued at US$25.00 and his or her income was $6500.00, he or she would pay 50% of the cost of the goods or services,or US$25.00×50%=US$12.50. Likewise, these persons would receive US$12.50 for each good or service they provided. A person at the top of the income scale such as someone whose income was US$75,000.00 would pay in full for the same goods and services offered to everyone at US$25.00. The producer of the goods and or services at this income level would receive US$2.50.

### CONCLUSIONS, RAMIFICATIONS, AND SCOPE

Accordingly the reader will see that the embodiment of this invention creates social and business relationships that have not been realized to such extent to date. This is a marketing plan for social change and resource reallocation through the sale and/or exchange of goods and services in which a method and system for marketing goods and services is based on the incomes of suppliers and purchasers. This promotes cooperative marketing in global economies. The structure of this method and system insures parity of purchasing or exchange power amongst people and entities of all income levels, and by doing so, is capable of improving the quality of life for people.

Although the above description contains many specificities, these should not be misconstrued as limiting the scope of this marketing system and method. Rather, they are exemplifications of the presently preferred embodiments of creating social change and resource reallocation. Many other ramifications and variations are possible within the scope of this plan. For example, transactions could take place through global e-markets where religious and spiritual communities, corporations or non-governmental organizations acting in the best interest of the poor could generate opportunities for them. Their assistance would give the poor more opportunities for better lives by giving them access to buyers with more expendable incomes. Because these entities are generally in place in most communities, this approach would reduce traditional capital investments ( wholesale and retail outlets) while ensuring marketing strategies that required little start up or overhead expenses. Thus the scope of this embodiment of a marketing plan for social change and resource reallocation through the sale and or exchange of goods and services should be determined by the appended claims and the laws of each sovereign nation in the world.

What is claimed is:

1. A system and method for social change through the sale or exchange of goods and services in a global environment which insures increased income for people who are poor and increased funds for those who are less poor by providing varieties of transactions over a period of time,
a) wherein the system of said transactions includes persons from every income level,
b) so that in the system of claim 1 said people agree upon the value of those goods and services,
c) thereby said persons agree to a remuneration framework wherein those people who have the greater incomes pay more than those people who have lesser income for the same goods and services in order to substantially create social change,
d) wherein such system includes an exponential methodology for developing resource reallocation in its financial structure,
e) such that this system includes a method of resource reallocation which is based on the exchange of goods and services and further includes analyses of said resource reallocation whenever changes in the global economic environment constitute or warrant that determination,
f) wherein said analysis of the global economic environment consists of representatives from many nation states,
g) wherein said representatives in this marketing plan for social change cooperate to benefit as many people as possible, especially those who are poor as they participate in the creation of or purchase or exchange of goods and services,
h) whereby this marketing plan for social change and resource reallocation creates business models which organize everyone in the global economic environment allowing them greater access to existent and future markets as they participate in the sale and or exchange of goods and services so that the sale or exchange of goods and services benefits poor people as set forth in these claims.
